(19) United States
(12) Patent Application Publication
(10) Pub. No.: US 2005/0265796 A1
(43) Pub. Date: Dec. 1, 2005

(54) Pin saving interchangeable core picking system

(76) Inventor: Kenneth Eugene Persson, East Rochester, NY (US)

Correspondence Address: Kenneth Persson, PO BOX 744, East Rochester, NY, 14445, US

(21) Appl. No.: 10/854,382

(22) Filed: May 25, 2004

(51) Int. Cl. B23B 35/00

(52) U.S. Cl. 408/1 R

(57) ABSTRACT

There is provided a method and apparatus for removing an interchangeable core (icore) of an interchangeable core or icore lock having (a) an icore housing; (b) a lock plug housing including a keyway, (c) a tumbler pins housing including stacks of tumbler pins; and (d) a control key movable sleeve having a thick lug segment including a projected cantilevered lug portion for retaining icore against a shoulder within the icore housing. The apparatus includes a mounting device for mounting a jig member against a front face of the icore lock; a drill set for drilling holes through the key plug housing and through the projected cantilevered lug portion; and a jig member mountable against the front face of the icore lock for guiding a drill from the drill set in precisely drilling a hole through the lock plug housing and through the projected cantilevered lug portion. The jig member has (i) at least one guiding throughbore formed through it for guiding a drill from the drill set in precisely drilling a hole having a longitudinal axis through the lock plug housing and through the projected cantilevered lug portion; and (ii) attaching devices including a key blank holding slot for attaching the jig member to the mounting device against the front face of the icore lock.

This disclosure relates to lock removal methods and apparatus or systems, and particularly to a pin saving interchangeable core picking system for nondestructively removing interchangeable cores from interchangeable core locks without a control key. The code saving system of the present disclosure enables removing such a core without picking or damaging the lock's code or the hardware on the door where such a lock is used.

As is well known, there are many times when for one reason or another, such as the loss of the control key, the owner of property locked with locks, in particular interchangeable core or icore locks using a control key in addition to an operating key, finds it necessary to call a locksmith to change the lock to the property when such control key cannot be located.

Interchangeable core locks or icore locks, such as the patented small format interchangeable core (SFIC) lock by Best Lock Corporation that is disclosed for example in U.S. Pat. No. 4,386,510, (to be described below), are generally very popular with institutional lock users. As stated above, occasionally, for reasons including breaches in security for example, an institutional lock user such as a school, hospital or hotel, with a large number of doors each locked by an interchangeable or removable core locks that are controllable by a common control key, will have a need to globally change such locks. If the control key however cannot be found, then that institutional lock user has a serious problem usually requiring trying to pick or remove the interchangeable core or cores without the control key.

Conventionally, it is known to insert a tension tool that has fine teeth into the keyway within the interchangeable core and attempt to manipulate and protrude the fine teeth into a series ejection holes at the bottom of the control sleeve of the interchangeable core. If and when successful, (and while the fine teeth are still protruding into and engaging this series of ejection holes), the positioning of this tension tool as such must then be secured firmly with toothpicks or other such shims. Necessary tension is then applied to such a tension tool in attempt to possibly effect a removal of the core. Unfortunately, this tension tool technique is extremely sensitive and difficult, and usually requires great skill, understanding, and time-consuming trial-and-error patience from the user. This is in part so because a particular alignment, without any bias, must be achieved and maintained in the shear area or interface between the control sleeve of the interchangeable core and the key plug when wedging, shimming or applying tension to the tension tool. This is because these locks are inherently made so that they are very difficult to pick, thus making the tension tool technique as well as other such techniques unlikely to be successful, or extremely time consuming and costly.

Conventionally too, other more certain attempts for removing the interchangeable core (icore) of an icore lock without the control key typically involve drilling the lock and core housing to destroy the core housing shoulder that otherwise is blocking the retaining lug portion of the removable core. This of course destroys each lock as well as the removable core housing and makes such attempts time consuming and costly. Another such approach is to drill out the bible, (that is, the full stack of tumbler pins) of the removable core or icore itself by drilling and destroy the tumbler pin stacks at the operating or control shear line. This approach of course destroys not only the icore, but also the pin code, and as such is also time consuming and costly.

There is therefore a need for a system or for apparatus and methods for nondestructively removing interchangeable cores (icores) from interchangeable core locks when the control key cannot be located.

### SUMMARY OF THE DISCLOSURE

In accordance with one aspect of the present disclosure, there is provided an apparatus for removing an interchangeable core (icore) of an interchangeable core or icore lock having (a) an interchangeable core housing; (b) a lock plug housing including a keyway having a key blade plane axis; (c) a tumbler pins housing including stacks of tumbler pins; and (d) a control key movable sleeve having a thick lug segment including a projected cantilevered lug portion for retaining icore against a shoulder within the icore housing. The apparatus includes a mounting device for mounting a jig member against a front face of the icore lock; a drill set for drilling holes through the key plug housing and through the projected cantilevered lug portion; and a jig member mountable against the front face of the icore lock for guiding a drill from the drill set in precisely drilling a hole through the lock plug housing and through the projected cantilevered lug portion. The jig member has (i) at least one guiding throughbore formed through it for guiding a drill from the drill set in precisely drilling a hole having a longitudinal axis through the lock plug housing and through the projected cantilevered lug portion; and (ii) attaching devices including a key blank holding slot for attaching the jig member to the mounting device against the front face of the icore lock.

In accordance with another aspect of the present disclosure, there is provided a method of drilling precisely located holes through the front face and into a body length of a lock having a keyway. The method includes (a) inserting a blade of a key blank fully into the keyway of the lock; (b) loosely fastening a jig member to said blade of said key blank, said jig member having a first side for positioning against the front face of the lock, precisely formed drill guiding throughbores, and a key blank blade receiving slot therein; (c) adjusting a position of the loosely fastened jig member so as to position said first side thereof flush against the front face of the lock; (d) tightly fastening the jig member with said first side thereof flush against the front face of the lock to locate the drill guiding throughbores for drilling the precisely located holes; and (e) guiding a drill through the guiding throughbores for drilling the precisely located holes through the front face and into a body length of the lock.

### BRIEF DESCRIPTION OF THE DRAWINGS

In the detailed description of the disclosure presented below, reference will be made to the drawings in which:

FIG. 1 is a plan view of each of the elements of the apparatus of the present disclosure for non-destructively picking or removing the icore of an icore lock without a control key;

FIG. 2 is an exploded view of the jig member assembly of FIG. 1 showing the jig member, handle setscrews and modified key blank;

FIG. 3 is a perspective view of the jig member assembly of FIG. 2 mounted on the key blank;

FIG. 4 is a vertical rear side view (relative to its use positioning) of the jig member assembly of FIG. 3;

FIG. 5 is a vertical front side view (relative to its use positioning) of the jig member assembly of FIG. 3;

FIG. 6 is a vertical left side view (relative to its use positioning) of the jig member assembly of FIG. 3 showing the handle attaching hole and setscrews thereof;

FIG. 7 is a plan view of the face of an interchangeable core lock installed in a door showing the icore front;

FIG. 8 is a perspective view of a control key removable core or icore 50 (not in its core housing) for non-destructive removal when in its core housing (FIG. 7) in accordance with the present disclosure;

FIG. 9 is a section taken along the front-ward facing view plane 9--9 of FIG. 8, showing the icore in a locked or retained position within the core housing forming a receptacle therefor;

FIG. 10 is an enlarged portion of a section taken along the rearward facing view plane 10--10 of FIG. 8, showing details of the lug-retaining portion of the icore control sleeve to be severed in accordance with the present disclosure;

FIG. 11 is the same enlarged portion of FIG. 10, showing the positions of starter holes and icore dislodging holes to be drilled therethrough in accordance with the present disclosure; and

FIG. 12 is a perspective schematic illustration of the jig member assembly drilling method of the present disclosure; and

FIG. 13 is a schematic perspective view of a drilled-out version 50′ of the icore of FIG. 8 showing the projected cantilevered or retaining lug portion severed and removed leaving only portions of the core dislodging holes 170, 172 in accordance with the present disclosure.

### DETAILED DESCRIPTION OF THE DISCLOSURE

Referring first to FIGS. 7-10, an interchangeable core lock 20 is shown (FIG. 7) having a core housing 22 defining a core insertion and removal path 24 and including a shoulder 26 for stopping a projected cantilevered lug portion 66 of an interchangeable core or icore 50. A good example of such locks is the small Format Interchangeable Core (SFIC)” locks, first made by Best Access Systems and disclosed for example in U.S. Pat. No. 4,386,510 as discussed above, the teachings and relevant portions of which are incorporated herein by reference. Such SFIC locks 20 come in six and seven pin versions and can use the same control keys for either version, with the keys for six pin locks sticking out of the keyway 56 a bit further than for the seven pin locks.

Such interchangeable core or icore locks 20 are very popular with medium-scale and large-scale institutional lock users because the ordinarily offer resistance against manipulation and picking. One important feature of these locks 20 is that a special control key can unlock and allow removal of the interchangeable core or icore 50 (that contains the keyway 56 and tumbler pins 60) from the front of the lock. Such removal thus allows new icores to be swapped in and out of the icore housing 22 in a few seconds as need be, and without the need for tools or special locksmithing skills. Ordinarily, most institutional users keep on hand a supply of extra or new icores that are rotated every so often in order to support routine re-keying for security purposes.

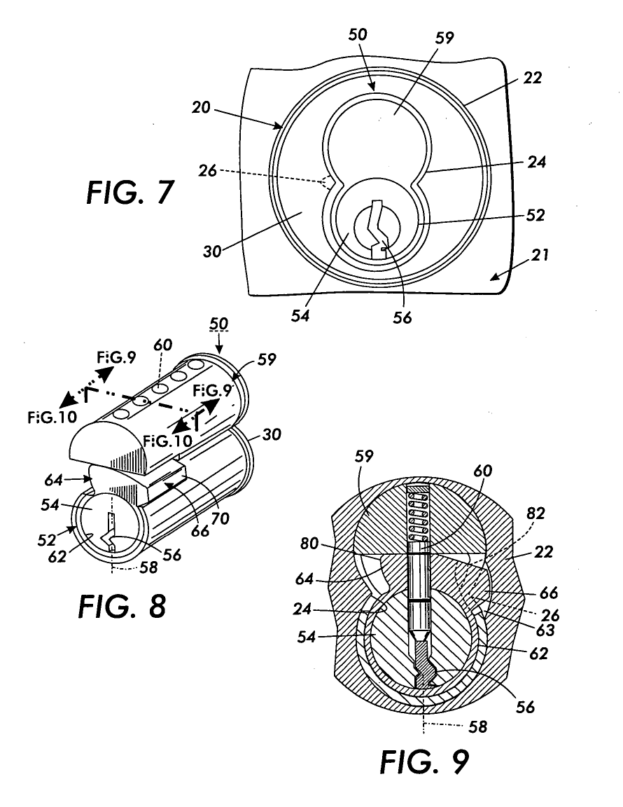

The interchangeable core or icore 50 as illustrated in FIGS. 8-11, has a lock plug housing 52 including a lock plug 54 a keyway 56. The lock plug 54 is rotatable by an operating key (not shown) within such lock plug housing 52. The keyway 56 has a key blade plane axis 58. The icore 50 has an upper lobe forming a pin tumbler housing 59 that has stacks of tumbler pins 60 mounted therein. The stacks of tumbler pins 60 therein that are aligned with the key blade plane axis 58, and typically above or in an upper position relative to the keyway 56 of a an installed lock 20.

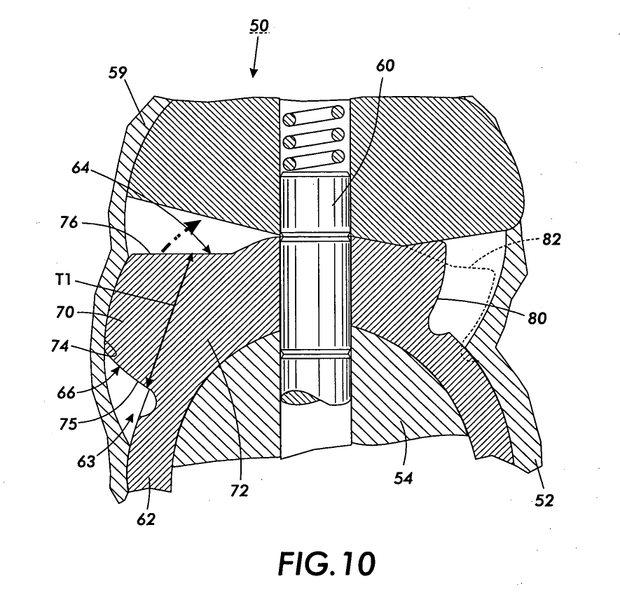

As is well known, the icore 50 also includes a control key movable sleeve 62 having a thick lug segment 64 (recessed from the front of the lock, that is closer to the rear end of the axial or longitudinal body length of the icore as shown in FIG. 8). The thick or recessed lug segment 64 includes a projected cantilevered lug portion 66 for retaining the interchangeable core or icore 50 against the shoulder 26 within the core housing 22. As illustrated in detail in FIGS. 9-10, the projected cantilevered lug portion 66 is typically in the form of a solid member 70 having a thickness T1, a first and inside-facing supporting end 72, an opposite outside-facing distal end 74, a bottom surface 75, and a top and opposite surface 76. As shown in FIG. 10, the projected cantilevered lug portion 66 has a projected or core retaining position 80 and a retracted icore release position 82, both of which are located to one side of the key blade plane axis 58 of the keyway 56 of an installed lock. The projected cantilevered lug portion 66 is moveable by a control key (not shown) between the projected or core retaining position 80 and the retracted icore release position 82.

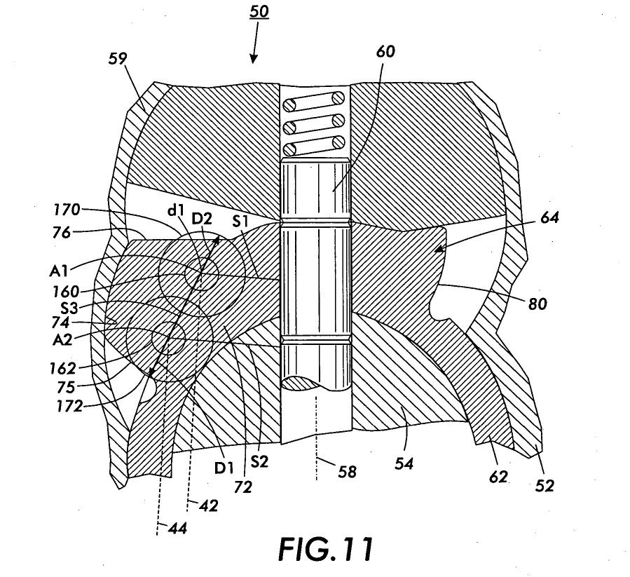

In the icore 50, the thick or recessed lug segment 64 of the control sleeve 62 is contained between the front and rear ends of the body length of the key plug housing 52 in a recess 63 that is formed into a top portion of the plug housing 52 as shown, and that extends upward into a lower portion of the pin tumbler housing 59. As pointed out above, the thick or recessed segment 64 carries a retaining lug or projected cantilevered lug portion 66 that, in the normal locked position 80 of the control sleeve 62, extends laterally beyond the normal core insertion and removal path 24 of the icore housing 22 of the lock, into locking engagement with the shoulder 26 within the icore housing or receptacle 22. The retaining or projected cantilevered lug portion 66 is shown in the core-locking position 80 in FIGS. 10 and 11.

As pointed above, occasionally and for reasons including breaches in security, for example, an institutional user (of the lock 20) such as a school, hospital or hotel, with a large number of doors locked by a series of interchangeable or removable icore locks 20 will have a need to globally change the icores 50 of such locks. If the control key however cannot be found, then that institutional lock user has the serious problem of trying to pick or remove the interchangeable cores or icores 50 without the control key.

Fortunately, there is now being provided in accordance with the present disclosure, a system or method and apparatus for the institutional user to employ that does not involve drilling the lock or icore housing 22 in order to destroy the core housing shoulder 26 that otherwise is blocking the retaining or projected cantilevered lug portion 66 and thus the removal of the icore 50. The method and apparatus of the present disclosure also do not have to involve drilling and destroy the tumbler pin stacks at the shear line. The method and apparatus of the present disclosure (to be described in detail below) allow the institutional user to remove the icore 50 by drilling out the retaining or projected cantilevered lug portion 66 of one icore 50 in a lock 20 in the series of locks, and in such a manner that the stacks of the tumbler pins 60 in such icore 50 are undamaged, and the lock's core housing 22 is also undamaged. The removed icore 50 then can be decoded from the undamaged pin stacks 60, and a new control key made from such decoding, thereby enabling the institutional user to then proceed to use the new control key to globally change the rest of the icores. As such, the method an apparatus of the present disclosure are significantly less time consuming and less expensive.

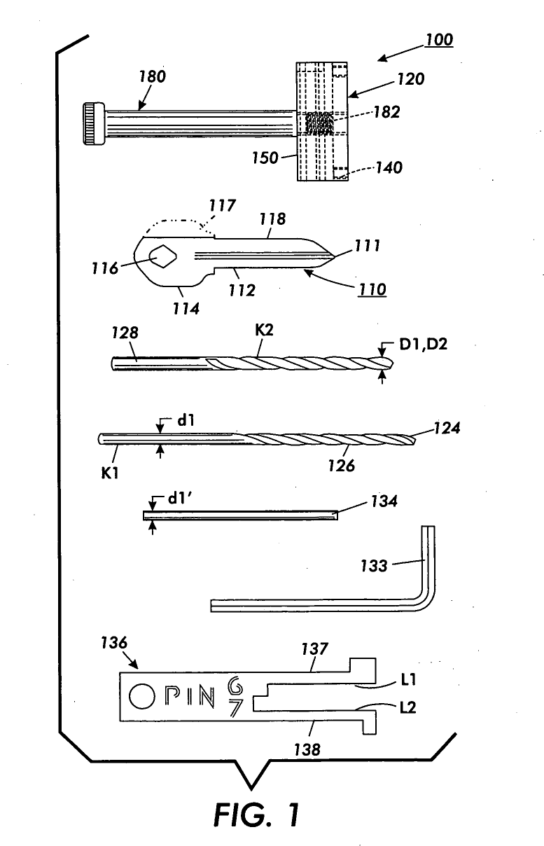

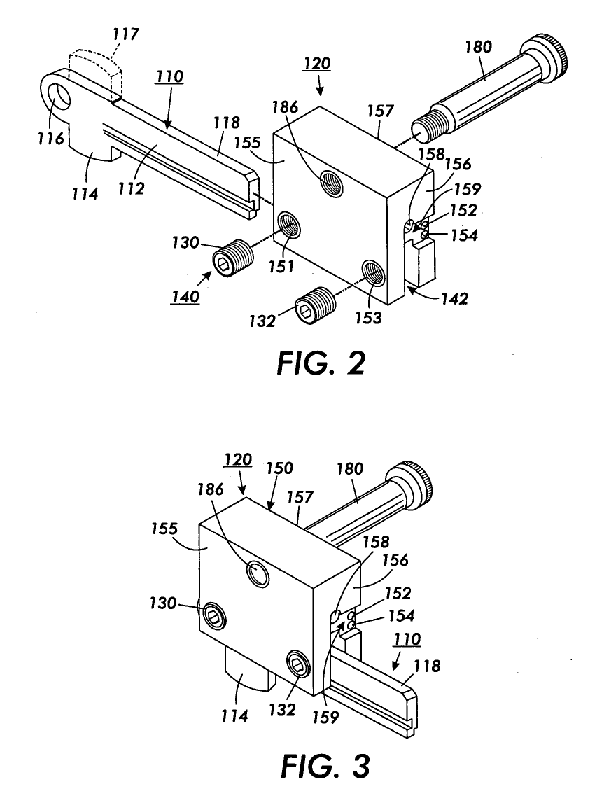

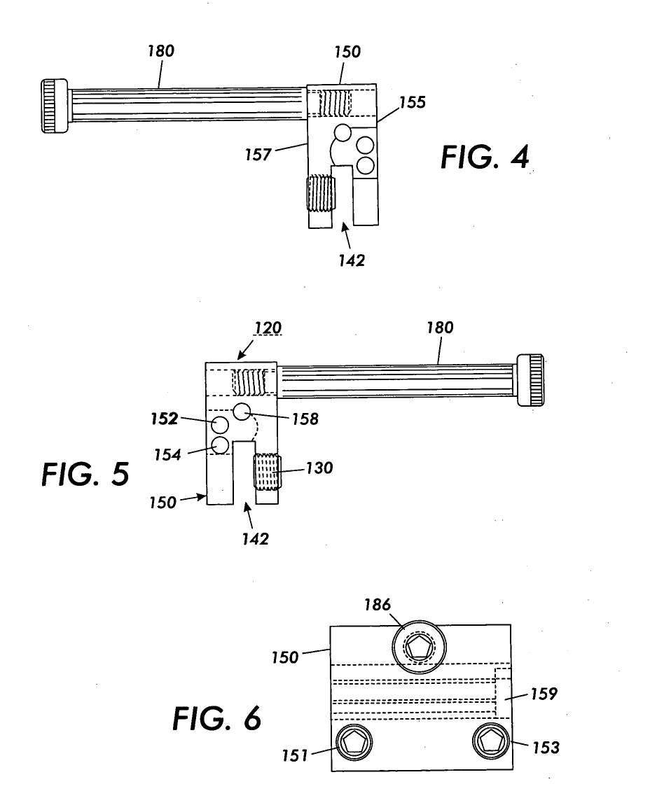

Referring now to FIGS. 1-6, and to FIGS. 10-13, the various components of the interchangeable core drilling (ICD) apparatus 100 of the present disclosure are illustrated for use according to the method of the present disclosure on the icore 50. As shown, the ICD apparatus 100 includes (a) a mounting device shown in the form of a modified key blank 110 for mounting a jig member assembly 120 against the front face 30 of the icore lock 20, (b) a drill set 124 for drilling holes (FIG. 11) through the key plug 54 and key plug housing 52, as well as through the projected cantilevered lug portion 66 of the icore 50, and (c) a jig member assembly 120 mountable against the front face 30 of the interchangeable core lock 20 for guiding a drill 126 from the drill set 124 in precisely drilling a hole 160, 162 through the lock plug housing 52 and through the projected cantilevered lug portion 66. As further shown in FIGS. 2-6, the jig member assembly 120 includes (i) a jig member 150, (ii) at least one guiding throughbore 152, 154 formed through the jig member 150 for guiding the drill 126 in precisely drilling a hole 160, 162 having a longitudinal axis A1, A2 through the lock plug housing 52 and through the projected cantilevered lug portion 66, and (iii) attaching devices 140 including a key blank holding slot 142 for attaching the jig member 150 to the mounting device 110 against the front face 30 of the interchangeable core lock 20.

The mounting device or key blank 110, for example, is an uncut key blank 110 that is selected so that it fits snuggly into the keyway 56 of the key plug 54 of the icore 50. The uncut key blank 110 has a blade 112, a bow 114, a key chain hole 116 and the shoulder forming portion 117 of the bow 114 thereof is cut off in order to level it with the rest of the top edge 118 of the key blank 110, thus enabling a flat or even and stable fit of the bow 114 within the key blank slot 142 of the jig member 150. The key blank 110 is mounted with the key blank slot 142 so that the key chain hole 116 in the bow 114 is aligned with one of two setscrew apertures 151, 153 within the jig member 150. The jig member 150 and the rest of the tools of the apparatus 100 can be made of hardened tool steel.

According to the present disclosure, when mounting the jig member 150 to the lock 20, the jig member handle 180 is additionally used to position the jig member 150 tightly against the front face 30 of the lock. As shown, the handle 180 has a threaded stem end 182 and is removably assembled to the jig member 150 with a threaded nut 184 through a handle assembly aperture 186. Advantageously, the handle 180 can be so assembled to extend to a first side, e.g., the right side 155 or to the opposite, left side 157 of the jig member depending on whether the user is right-handed or left-handed.

The attaching devices 140 for attaching the jig member 150 to the mounting device 110 include the key blank slot 142, the pair of setscrew apertures 151, 153, a pair of setscrews 130, 132, and an Allen wrench 133. The set screw apertures 151, 153 are located so that one of them is alignable with the key chain hole 116 of the key blank 110 inserted into the key blank slot 142.

The drill set 124 of the ICD apparatus 100 includes a starter first drill 126 having a first starter diameter d1 and a first length k1 for drilling starter holes 160, 162, and at least one reamer second drill 128 having a second length k2 and a second diameter for example D1, D2, that is significantly greater than the first starter diameter d1. Although one reamer second drill 128 is shown having a diameter D1, D2 that will be used to drill the two dislodging holes 170, 172, it is understood that two different reamer drills having different diameters D1, D2 can equally be used, provided the two dislodging holes 170, 172 overlap to form a slot that completely severs or shears off the projecting cantilevered lug portion 66. In either case, the reamer second drill 128 is used for concentrically reaming out and enlarging the first starter holes 160, 162 in order to create the core dislodging holes 170, 172 having the first and second dislodging hole diameters D1, D2. Generally, the plug 54 and plug housing 52 of typical icores 50 are made of brass, and so a suitable material for the drills 126, 128 for example is hardened tool steel. In accordance with the present disclosure, the starter first drill 126 is longer and thinner than the reamer second drill 128.

As further shown, the ICD apparatus 100 also includes an aligning pin 134 having a diameter d1′ that is approximately equal to the starter drill diameter d1. As such, the integrity and alignment of the second starter hole 162 being drilled to the first drilled hole 160 can be assured by inserting the aligning pin 134 into the first starter hole 160 (after the first starter hole has been drilled through the interchangeable core lock 20) while drilling the second starter hole 162. Additionally, the ICD apparatus 100 as pointed out above also includes a drill length determining gauge device 136 for determining a correct length of each drill to use for drilling. As shown on the gauge device 136, a correct first drilling depth length L1 of the starter first drill 126 will be that portion of the starter drill 126 that will lie beyond a drill chuck (not shown) and that will penetrate during drilling of a six-pin icore 50. Similarly, a correct second drilling depth length L2 of the starter first drill 126 will be that portion of the starter drill 126 that will lie beyond a drill chuck (not shown) and that will penetrate during drilling of a seven-pin icore 50. Thus the drill gauge device 136 allows one to adjust the drilling depth length L1, L2 of a drill 126, 128 protruding from the front of one's drill chuck for both 6- and 7-pin Interchangeable core housings. Using the ICD apparatus 100 thus requires initial determination if one is drilling a 6-pin or 7-pin icore.

The jig member 150 as shown includes a first rear side 156 shaped for having a flush fit against the front face 30 the interchangeable core lock 20. The first side 156 includes a shavings recess 159 formed into the first side 156 and over the first and the second throughbores 154 for receiving drill shavings coming out of the front face 30 of the interchangeable core lock 20 from a starter hole 160, 162 being drilled through the lock plug housing 52 and through the projected cantilevered lug portion 66.

The at least one guiding throughbore 152, 154 in the jig member 150 includes (a) a first guiding throughbore 152 for guiding a drill 126 from the drill set 124 in precisely drilling a first starter hole 160, at a first position having a first longitudinal axis A1, through the lock plug housing 52 and through the projected cantilevered lug portion 66, and (ii) a second guiding throughbore 154 for guiding the drill 126 in precisely drilling a second starter hole 162, at a second position having a second longitudinal axis A2, through the lock plug housing 52 and through the projected cantilevered lug portion 66. The first guiding throughbore 152 and the second guiding throughbore 154 are located offset to one side of the key blank blade plane axis 58 of the key blank slot 142.

In cases where the top surface 76 of the projected cantilevered lug portion 66 is curved, a first vertical line 42 through the first longitudinal axis A1 of the first throughbore 152 that is parallel to the key blank blade plane axis 58 will be offset from a second vertical line 44 through the second longitudinal axis A2 of the second throughbore 154. A third single hole or throughbore 158 located to the top of the key blank slot 142 can optionally be used to locate and create a starter hole 160, 162 for drilling the tumbler pins 60 at a shear line 28 of the interchangeable core 50.

For operation or using the present disclosure, one should select an appropriate key blank 110 that will fit snuggly into the keyway 56. One may select a 6- or 7-pin key blank 110 for either a 6- or 7-pin icore 50. A master key blank 110 that fits multiple keyways should not be selected because master key blanks are too thin to fit properly into particular keyways. An improper fit thus may result in excessive motion and wobble of the mounted jig member 150 thereby resulting in possible failure of the drilling process. Similarly, a key blank that has already been cut into some type of key also should not be used as it may have a tendency to push the jig member 150 away from the front face 30 of the lock 20.

With the proper key blank 110 selected as above, cut off the top portion 117 of the key bow 114. The top edge 118 of the key blank blade 112 thus becomes one straight line from the tip 111 all the way to the bow 114. This will allow the key blank 110 to rest fully into the key blank slot 142 in jig member. Caution should be exercised not to damage the key chain hole 116 in the bow of the key blank as this will be used with one of the setscrews 130, 132 as a fixture set point. As pointed out above, the jig member handle 180 can then be assembled to fit one's use: If you are right-handed, then place the handle on the left hand side 155 of the jig member 150. Left-handed persons may want the handle 180 to protrude from the right-hand or opposite side 157.

To attach the jig member 150, insert the altered or edge-modified key blank 110 into the key blank slot 142 of the jig member, making sure to initially leave a loose fit with the setscrews 130, 132. Also be sure to insert the key blank 110 so that the rear setscrew 132 (that is, the set screw closest to the Locksmith), is aligned and centered on the key chain hole 116. Then insert the key blank 110 (with the attached jig member 150) into the keyway 56 of the lock 20.

With the set screws loosely fastened as above, move the jig member 150 into contact with the front face 30 of the lock 20 so that the first side 156 of the jig member is flush with the front face 30 of the lock. Then with the top edge 118 of the key blank 110 up tight into the key blank slot 142, tighten the setscrews 130, 132 using the Allen wrench provided. There may be some door hardware where the jig member 150 cannot fit up tight against the Interchangeable core lock 20. In such a case, you may wish to take an Interchangeable core lock that is out of the cylinder housing to set the jig member up properly. In addition, be sure to maintain a 90-degree angle between the front face 30 of the lock 20 and longitudinal axis of the key blank 110 for the drill angles of the jig member to maintain integrity.

Before starting to drill, visually check to insure if there is an air gap between the first side 156 of the jig member 150 and the front face 30 of the Interchangeable core lock. If there is such an air gap, you can compensate for this by making the drill length L1 slightly longer.

To drill, insert the longer or starter hole drill 126 of the drill set 124 into your drill chuck, and use the appropriate member 137, 138 of the drill gauge 136 to set the drill length L1, L2 exterior to the drill's chuck. Using the starter drill 126, drill your first starter hole 160 into the interchangeable core or icore lock 20 using the top or higher position throughbore 152 of the two throughbores 152, 154 on the left side of the key blank slot 142 of the jig member. In doing so, let the drill 126 do the work because excess force applied to the drill will introduce drill wander resulting in uncertain results. Since the flute of the drill is shallow, partially withdraw the drill often in order to allow the shavings from the drilling to exit into the chip removal undercut or recess 159 on the face of the first side 156 of the jig member 150. Be sure never to attempt to drill through the jig member with any drill larger than the starter drill 126 with the diameter d1. This is because you will permanently damage the jig member 150. Drill into the interchangeable core lock. 20 until you break through the back of the icore 50.

With the first hole drilled, remove the starter drill 126 and insert the steel-locating or aligning pin 134 into the drilled hole. This will hold the jig member in alignment for the close spacing tolerances required between the two starter holes 160, 162 being drilled. Drill the second starter hole 162. Once the second starter hole 162 has been drilled successfully, remove the jig member 150 by removing the key blank 110 from the keyway 56 of the lock.

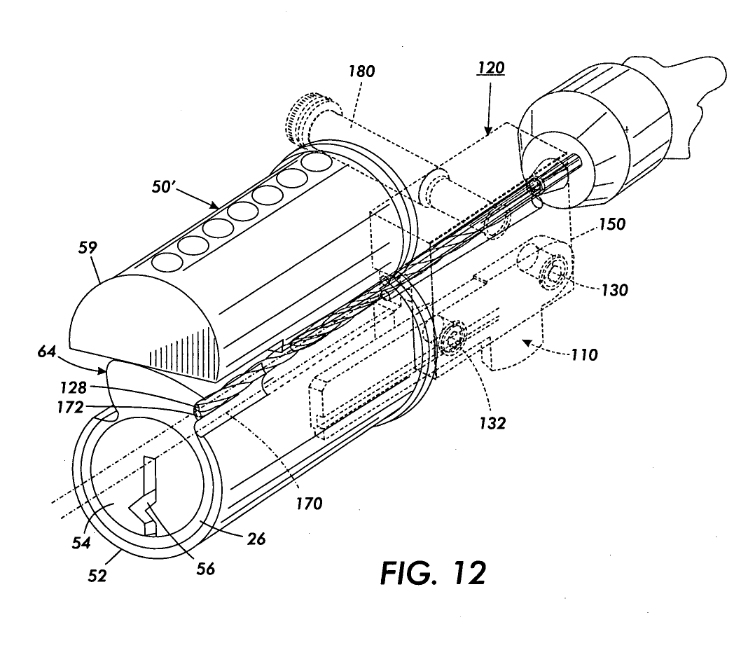

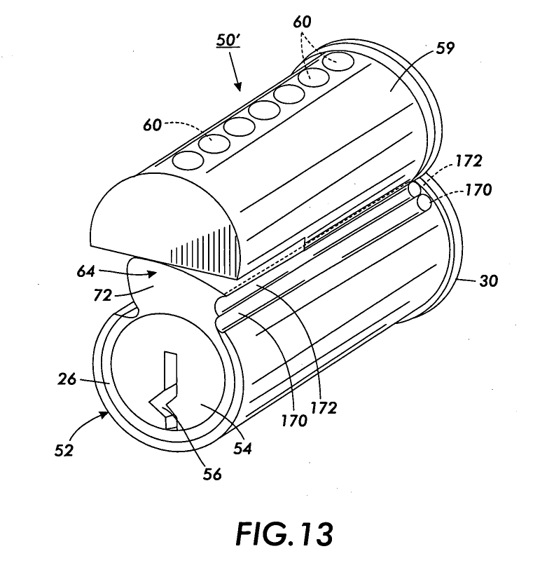

Then change or switch drills from the starter drill 126 to the thicker, shorter reamer second drill 128, and again use the appropriate or center gauge slot 142 of the drill gauge device 136 to determine and set the drill length L2. After that carefully run the shorter larger drill 128 through each of the starter holes 160, 162 the to ream out and enlarge each into a core dislodging hole 170, 172 having the diameters D1, D2, and until a breakthrough is accomplished. Inspect the pair of core dislodging holes 170, 172 and insure that the holes did overlap, and that you have turned the two overlapping holes into one slot with no webbing remaining, and with the projected cantilevered lug portion 66 completely severed from the recessed lug segment 64 of the control sleeve 62 resulting in a drilled out icore 50′ as shown in FIGS. 12 and 13.

With this accomplished, use any suitable means to grip the drilled out icore 50′, give it a stout pull to extract the drilled out icore 50′ with the severed projected cantilevered lug portion 66 being left behind against the shoulder 26 within the core housing 22 of the lock. If the drilled out icore 50′ is stubborn against such a pull, you can take another key blank (not shown) that will enter the keyway 56, randomly cut or form a couple of wide bittings into the edge of the blade of such a key blank. Then insert this key blank into the keyway 56 only far enough until one of the formed bittings catches or is engaged by one of the pin tumblers 60. Then attach a pair of pliers to this key blank and pull to help extract the drilled out icore 50′. After that, this key blank can itself be removed by using a Sidewinder Extractor for example along side of the key blank to lift the engaging pin tumblers 60.

Thus one method of the present disclosure of drilling precisely located holes 160, 162 through the front face 30 and into a body length of a lock 20 having a keyway 56 includes (a) inserting a blade 112 of a key blank 110 fully into the keyway 56 of the lock 20; (b) loosely fastening the jig member 150 to the blade 112 of the key blank, where the jig member 150 has (i) a first side 156 for positioning against the front face of the lock, (ii) precisely formed drill guiding throughbores 152, 154 and (iii) a key blank blade receiving slot 142 therein. The method also includes (c) adjusting a position of the loosely fastened jig member 150 so as to position the first side 156 thereof flush against the front face of the lock; (d) tightly fastening the jig member with the first side thereof flush against the front face of the lock to locate the drill guiding throughbores 152, 154 for drilling the precisely located holes; and (e) guiding a drill 126 through the guiding throughbores for drilling the precisely located holes 160, 162 through the front face and into a body length of the lock.

In accordance with another aspect of the present disclosure, the method of removing an interchangeable core 50 of an interchangeable core lock 20 (having (a) a core housing 22 defining a core insertion and removal path 24 and including a shoulder 26 for stopping a projected cantilevered lug portion; (b) a lock plug housing 52 including a keyway 56 having a key blade plane axis 58; (c) a tumbler pins housing 59 including stacks of tumbler pins 60 aligned with the key blade plane axis; and (d) a control key movable sleeve 62 having a thick lug segment 64 including a projected cantilevered lug portion 66 for retaining the interchangeable core 50 against the shoulder 26 within the core housing 22, where the projected cantilevered lug portion 66 comprises a solid member having a thickness T1, a first and inside-facing supporting end 72, an opposite outside-facing distal end 74, a bottom surface 75, and a top and opposite surface 76, and where the projected cantilevered lug portion 66 is in a core retaining position 80 located to one side of the key blade plane axis 58 of the keyway 56), includes (i) drilling a first dislodging hole 170 having a first diameter D1 through the lock plug housing 52 and through the front edge to the rear edge of the projected cantilevered lug portion 66 such that the first dislodging hole 170 has a first position including a first longitudinal axis A1 passing through the thickness T1 of the projected cantilevered lug portion 66 with the first position being at the inside-facing supporting end 72, adjacent one of the top surface 76 and the bottom surface 75, and so as to space the first dislodging hole 170 from the stacks of tumbler pins 60; and (ii) drilling a second dislodging hole 172 having a second diameter D2 through the lock plug housing 52 and through the front edge to the rear edge of the projected cantilevered lug portion 66, with the second diameter D2 being selected so that D1+D2 is at least equal to T1, and so that the second dislodging hole 172 has a second position including a second longitudinal axis A2 also passing through the thickness T1 of the projected cantilevered lug portion 66 and spacing the second dislodging hole 172 from the stacks of tumbler pin stacks 60, the second dislodging hole 172 as drilled overlapping the first dislodging hole 170 for severing the thickness T1 and dislodging the projected cantilevered lug portion 66 of the thick lug segment 64, thereby allowing the drilled out interchangeable core 50′ to be removed from the core housing 22 without a control key and without damage to any of the core housing or to the stacks of tumbler pins 60.

In addition, drilling the first dislodging hole 170 includes selecting the first diameter D1 so that one half of D1 is less than a first distance S1 from the first longitudinal axis A1 to the stack of tumbler pins 60, and drilling the second dislodging hole 172 includes selecting the second diameter D2 so that one half of D2 is less than a second distance S2 from the second longitudinal axis A2 to the stack of tumbler pins 60. Selecting the first diameter D1 and the second diameter D2 should be such that one half of D1 plus one half of D2 is less than a third distance S3 from the first longitudinal axis A1 to the second longitudinal axis A2.

The method also includes inserting and retaining an aligning pin 134 through the first dislodging hole 170 while drilling the second dislodging hole 172, as well as determining a drilling depth from the front face 30 of the interchangeable core 50 to the rear edge of the projected cantilevered lug portion 66.

The drilling of the first dislodging hole 170 may include first drilling a first starter hole 160 at the first position such that the first starter hole 160 has a first starter diameter d1 that is significantly less than the first diameter D1 of the first dislodging hole 170. Similarly, drilling the second dislodging hole 172 may include first drilling a second starter hole 162 at the second position such that the second starter hole 162 has a second starter diameter d2 that is significantly less than the second diameter D2 of the second dislodging hole 172.

The method of the present disclosure may also be seen as including (i) determining a value for the thickness T1; (ii) selecting the first diameter D1 for the first dislodging hole 170 and the second diameter D2 for the second dislodging hole 172 so that D1 plus D2 is at least equal to T1; (iii) selecting the first position including the first longitudinal axis A1 on the front of the interchangeable core 50 so that one half of D1 is less than a first distance S1 from the first longitudinal axis A1 to the stack of tumbler pins; (iv) selecting the second position including the second longitudinal axis A2 on the front of the interchangeable core so that one half of D2 is less than a second distance S2 from the second longitudinal axis A2 to the stack of tumbler pins, and so that one half of D1 plus one half of D2 is less than a third distance S3 from the first longitudinal axis A1 to the second longitudinal axis A2; (v) drilling the first dislodging hole 170 at the first position having the first diameter D1; and (vi) drilling the second dislodging hole 172 at the second position having the second diameter D2 hole for severing the thickness T1 and dislodging the projected cantilevered lug portion 66 of the thick lug segment 64, thereby allowing the drilled out interchangeable core 50′ to be removed from the core housing without a control key and without damage to any of the core housing and the stacks of tumbler pins.

In particular, it is noted that the apparatus 100 and the method of the present disclosure disclose drilling two or more non-shear line starter holes strategically as shown and described, and then enlarging or expanding at least two of such starter holes by reaming each out into core dislodging holes that form a continuous slot for completely severing or shearing off the projected cantilevered lug portion from the control sleeve, thereby dislodging the projected cantilevered lug portion, and allowing the icore to be pulled out of the icore housing of the lock, despite the retaining shoulder in the icore housing.

As indicated and described, the apparatus and method of the present disclosure in clued the key blank 110 that has the blade 112 and the bow 114. The top portion 117 of the bow 114 is cut off to form a straight line with the rest of the top edge 118 of the blade 112. The remaining bow portion includes the key chain hole 116. In attaching the jig member assembly 120 to the key blank 110, the key chain hole 116 is aligned for engagement by one of the setscrews 130, 132 in order to firmly secure the jig member 150 to the key blank 110.

It is noted again that in accordance with the present disclosure, the projected cantilevered lug portion 66 is drilled and dislodged from the icore 50 as described herein while the icore 50 is still installed in the icore housing 22 of an icore lock 20 that itself is still installed in the door 21 locked by such lock.

In accordance with the apparatus and method of the present disclosure, the purpose of the jig member assembly 120 is to prevent drill bit or drill wander during drilling through multiple layers of the icore 50, thereby allowing the starter holes 170, 172 to be drilled neatly and accurately without undesirable damage to the icore housing 22 or to the tumbler pin stacks 60.

As can be seen, according to one aspect of the present disclosure, there has been provided an apparatus for removing an interchangeable core (icore) of an interchangeable core or icore lock having (a) an icore housing; (b) a lock plug housing including a keyway, (c) a tumbler pins housing including stacks of tumbler pins; and (d) a control key movable sleeve having a thick lug segment including a projected cantilevered lug portion for retaining icore against a shoulder within the icore housing. The apparatus includes a mounting device for mounting a jig member against a front face of the icore lock; a drill set for drilling holes through the key plug housing and through the projected cantilevered lug portion; and a jig member mountable against the front face of the icore lock for guiding a drill from the drill set in precisely drilling a hole through the lock plug housing and through the projected cantilevered lug portion. The jig member has (i) at least one guiding throughbore formed through it for guiding a drill from the drill set in precisely drilling a hole having a longitudinal axis through the lock plug housing and through the projected cantilevered lug portion; and (ii) attaching devices including a key blank holding slot for attaching the jig member to the mounting device against the front face of the icore lock.

As can also be seen, according to another aspect of the present disclosure, there has been provided a method of drilling precisely located holes through the front face and into a body length of a lock having a keyway. The method includes (a) inserting a blade of a key blank fully into the keyway of the lock; (b) loosely fastening a jig member to said blade of said key blank, said jig member having a first side for positioning against the front face of the lock, precisely formed drill guiding throughbores, and a key blank blade receiving slot therein; (c) adjusting a position of the loosely fastened jig member so as to position said first side thereof flush against the front face of the lock; (d) tightly fastening the jig member with said first side thereof flush against the front face of the lock to locate the drill guiding throughbores for drilling the precisely located holes; and (e) guiding a drill through the guiding throughbores for drilling the precisely located holes through the front face and into a body length of the lock.

1. A method of removing an interchangeable core of an interchangeable core lock having (a) an interchangeable core housing defining a core insertion and removal path and including a shoulder for retaining a projected cantilevered lug portion; (b) a lock plug housing including a keyway having a key blade plane axis; (c) a tumbler pins housing including stacks of tumbler pins aligned with said key blade plane axis; and (d) a control key movable sleeve having a thick lug segment including a projected cantilevered lug portion for retaining the interchangeable lock core against said shoulder within the core housing, said projected cantilevered lug portion comprising a solid member having a thickness T1, a front edge and a rear edge, a first inside-facing and supporting end, an opposite second outside-facing and distal end, a bottom surface, and a top and opposite surface, and said projected cantilevered lug portion being in a core retaining position located to one side of said key blade plane axis of said keyway, the method comprising:
(i) drilling a first dislodging hole having a first diameter D1 through said lock plug housing and through said front edge to said rear edge of said projected cantilevered lug portion, said first dislodging hole having a first position including a first longitudinal axis passing through said first position within said thickness T1 of said projected cantilevered lug portion, said first position being towards said first inside-facing supporting end, adjacent one of said top surface and said bottom surface, and spacing said first dislodging hole from said stacks of tumbler pins; and
(ii) drilling a second dislodging hole having a second diameter D2 through said lock plug housing and through said front edge to said rear edge of said projected cantilevered lug portion, said second diameter D2 being selected so that D1+D2 is at least equal to T1, said second dislodging hole having a second position including a second longitudinal axis passing through said second position within said thickness T1 of said projected cantilevered lug portion, said second position spacing said second dislodging hole from said stacks of tumbler pins and being adjacent said first inside-facing supporting end between said top surface and said bottom surface, and said second position being selected so that said second dislodging hole as drilled overlaps said first dislodging hole for severing said thickness T1 and dislodging said projected cantilevered lug portion of said thick lug segment, thereby allowing the interchangeable core to be removed from said core housing without a control key and without damage to the core housing and to the stacks of tumbler pins.

2. The method of claim 1, wherein drilling said first dislodging hole includes selecting said first diameter D1 so that one half of D1 is less than a first distance S1 from said first longitudinal axis to said stack of tumbler pins.

3. The method of claim 1, wherein drilling said second dislodging hole includes selecting said second diameter D2 so that one half of D2 is less than a second distance S2 from said second longitudinal axis to said stack of tumbler pins.

4. The method of claim 1, including selecting said first diameter D1 and said second diameter D2 so that one half of D1 plus one half of D2 is less than a third distance S3 from said first longitudinal axis to said second longitudinal axis.

5. The method of claim 1, including inserting and retaining an aligning member through said first dislodging hole while drilling said second dislodging hole.

6. The method of claim 1, including determining a drilling depth from the front of the interchangeable core lock to said rear edge of said projected cantilevered lug portion.

7. The method of claim 1, drilling said first dislodging hole includes first drilling a first starter hole at said first position, said first starter hole having a first starter diameter d1 significantly less than the first diameter D1 of said first dislodging hole.

8. The method of claim 1, drilling said second dislodging hole includes first drilling a second starter hole at said second position, said second starter hole having a second starter diameter d2 significantly less than the second diameter D2 of said second dislodging hole.

9. A method of removing an interchangeable core of an interchangeable core lock having (a) a core housing defining a core insertion and removal path and including a shoulder for stopping a projected cantilevered lug portion; (b) a lock plug housing including a keyway having a key blade plane axis; (c) a tumbler pins housing including stacks of tumbler pins aligned with said key blade plane axis; and (d) a control key movable sleeve having a thick lug segment including a projected cantilevered lug portion for retaining the interchangeable lock core against said shoulder within the core housing, said projected cantilevered lug portion comprising a solid member having a thickness T1, a rear edge, a front and opposite edge, a bottom surface, a top and opposite surface, an inside-facing supporting end, and an opposite outside-facing distal end, and said projected cantilevered lug portion being in a core retaining position located to one side of said key blade plane axis of said keyway, the method comprising:
(i) determining a value for the thickness T1;
(ii) selecting a first diameter D1 for a first dislodging hole and a second diameter D2 for a second dislodging hole so that D1 plus D2 is at least equal to T1;
(iii) selecting a first position including a first longitudinal axis A1 on the front of the interchangeable core lock so that one half of D1 is less than a first distance S1 from said first longitudinal axis A1 to said stack of tumbler pins;
(iv) selecting a second position including a second longitudinal axis A2 on the front of the interchangeable core lock so that one half of D2 is less than a second distance S2 from said second longitudinal axis A2 to said stack of tumbler pins, and so that one half of D1 plus one half of D2 is less than a third distance S3 from said first longitudinal axis A1 to said second longitudinal axis A2;
(v) drilling a first dislodging hole at said first position having said first diameter D1; and
(vi) drilling a second dislodging hole at said second position having said second diameter D2 hole for severing said thickness T1 and dislodging said projected cantilevered lug portion of said thick lug segment, thereby allowing the interchangeable core to be removed from said core housing without a control key and without damage to any of the core housing and the stacks of tumbler pins.

10. Apparatus for removing an interchangeable core of an interchangeable core lock having (a) a core housing defining a core insertion and removal path and including a shoulder for stopping a projected cantilevered lug portion; (b) a lock plug housing including a keyway having a key blade plane axis; (c) a tumbler pins housing including stacks of tumbler pins aligned with said key blade plane axis; and (d) a control key movable sleeve having a thick lug segment including a projected cantilevered lug portion for retaining the interchangeable lock core against said shoulder within the core housing, said projected cantilevered lug portion comprising a solid member having a thickness T1, a rear edge, a front and opposite edge, a bottom surface, a top and opposite surface, an inside-facing supporting end, and an opposite outside-facing distal end, and said projected cantilevered lug portion being in a core retaining position located to one side of said key blade plane axis of said keyway, the apparatus comprising:
(A) mounting means for mounting a jig member against a front face of the interchangeable core lock;
(B) a drill set for drilling holes through said key plug housing and through said projected cantilevered lug portion; and
(C) a jig member mountable against said front face of the interchangeable core lock for guiding a drill from said drill set in precisely drilling a hole through said lock plug housing and through said projected cantilevered lug portion, said jig member including:
(i) at least one guiding throughbore formed therethrough for guiding a drill from said drill set in precisely drilling a hole having a longitudinal axis through said lock plug housing and through said projected cantilevered lug portion; and
(ii) attaching means including a key blank holding slot for attaching said jig member to said mounting means against a front face of the interchangeable core lock.

11. The apparatus of claim 10, wherein said mounting means comprise an uncut key blank for fitting snuggly into said keyway of said key plug.

12. The apparatus of claim 10, wherein said mounting means comprise an uncut key blank for fitting snuggly into said keyway of said lock plug housing, and a jig member handle for use in positioning said jig member tightly against the front face of the interchangeable core lock.

13. The apparatus of claim 10, wherein said drill set includes a starter first drill having a first starter diameter d1 and a first length L1 for drilling said first starter hole.

14. The apparatus of claim 10, wherein said drill set includes a starter first drill having a first starter diameter d1 for drilling starter holes through said lock plug housing and through said projected cantilevered lug portion, and a reamer second drill having a second diameter D2 greater than said first starter diameter d1 for concentrically reaming and enlarging each hole of said starter holes to form core dislodging holes through said lock plug housing and through said projected cantilevered lug portion.

15. The apparatus of claim 10, wherein said jig member includes a first rear side shaped for having a flush fit against the front face the interchangeable core lock.

16. The apparatus of claim 10, wherein said at least comprises (a) a first guiding throughbore for guiding a drill from said drill set in precisely drilling a first starter hole, at a first position having a first longitudinal axis, through said lock plug housing and through said projected cantilevered lug portion; and (ii) a second guiding throughbore for guiding a drill from said drill set in precisely drilling a second starter hole, at a second position having a second longitudinal axis, through said lock plug housing and through said projected cantilevered lug portion.

17. The apparatus of claim 10, wherein said attaching means includes said key blank holding slot, a pair of set screw apertures, and a pair of set screws for attaching said jig member to said mounting means against a front face of the interchangeable core lock.

18. The apparatus of claim 11, wherein said uncut key blank has a key chain hole and a severed bow tail.

19. The apparatus of claim 13, wherein said drill set includes a reamer second drill having a second diameter d2 greater than said first starter diameter d1 for concentrically reaming and enlarging said starter hole to form a core dislodging hole through said lock plug housing and through said projected cantilevered lug portion.

20. The apparatus of claim 14, including an aligning pin for inserting into a first starter hole drilled through the front face and entire body length of the interchangeable core lock while drilling a second starter hole through the front face and entire body length of the interchangeable core lock.

21. The apparatus of claim 14, including a gauge device for determining a correct length for said starter first drill and for said reamer second drill so as to ensure completely drilling through said projected cantilevered lug portion.

22. The apparatus of claim 15, including a shavings recess formed into said first surface and over said first and said second throughbores for receiving drill shavings coming out of the front face of the interchangeable core lock from a starter hole being drilled through said lock plug housing and through said projected cantilevered lug portion.

23. The apparatus of claim 16, wherein said first guiding throughbore and said second guiding throughbore are located offset to one side of said key blank blade plane axis of said key blank slot.

24. The apparatus of claim 16, wherein a first line through said first longitudinal axis of said first throughbore and parallel to said key blank blade plane axis is offset from a second line through said second longitudinal axis of said second throughbore.

25. A method of drilling precisely located holes through the front face and into a body length of a lock having a keyway, the method comprising:
(a) inserting a blade of a key blank fully into the keyway of the lock;
(b) loosely fastening a jig member, having precisely formed drill guiding throughbores and a key blank blade-receiving slot, to said blade of said key blank inserted into said keyway;
(c) adjusting a position of the loosely fastened jig member to be flush against the front face of the lock;
(d) tightly fastening said jig member in said position against the front face of the lock to locate said drill guiding throughbores for drilling the precisely located holes; and
(e) guiding a drill through said guiding throughbores for drilling precisely located holes through the front face and into a body length of the lock.

26. A jig member for drilling precisely located holes through the front face and into a body length of a lock having a keyway, the jig member comprising:
(a) a first side for placing flushly against the front face of the lock and a second and opposite side from said first side defining a jig thickness;
(b) drill guiding throughbores formed into said second side through to said first side for guiding drills to drill precisely located holes through the front face and into the body length of a lock;
(c) a blade receiving slot formed into a portion of said jig thickness for receiving a first portion of a blade of a key blank including a second portion insertable into said keyway of the lock; and
(d) fastening means for fastening to said jig member within said blade receiving slot, said first portion of said blade of said key blank.
